(19) United States
(12) Patent Application Publication
(10) Pub. No.: US 2013/0199319 A1
(43) Pub. Date: Aug. 8, 2013

(54) Eccentric Bearing

(71) Applicants: Juergen Haecker, Schwieberdingen (DE); Norbert Alaze, Markgroeningen (DE)

(72) Inventors: Juergen Haecker, Schwieberdingen (DE); Norbert Alaze, Markgroeningen (DE)

(73) Assignee: Robrt Bosch GmbH, Stuttgart (DE)

(21) Appl. No.: 13/695,667

(22) PCT Filed: Mar. 10, 2011
(86) PCT No.: PCT/EP11/53589

§ 371 Date: Mar. 14, 2013

(30) Foreign Application Priority Data
May 5, 2010 (DE) 10 2010 028 594.3

(51) Int. Cl. F16H 53/02

(52) U.S. Cl. CPC F16H 53/025
USPC 74/55

(57) ABSTRACT

An eccentric bearing for an electrohydraulic piston pump assembly of a vehicle brake system includes a shaft configured to be driven in rotation about its axis, a bearing ring eccentric relative to the shaft, and rolling bodies between the bearing ring and the shaft. The rolling bodies have different diameters corresponding to a varying width of a gap between the bearing ring and the shaft. When the shaft is driven in rotation, an eccentricity of the bearing ring circulates around the shaft at half of the rotational speed of the shaft and drives pump pistons, which bear against the bearing ring, to perform a reciprocating movement. A resiliently elastic, closed annular steel band surrounds the rolling bodies and loads the rolling bodies inwardly against a circumference of the shaft. The steel band ensures that the rolling bodies roll on the shaft when the shaft is driven in rotation.

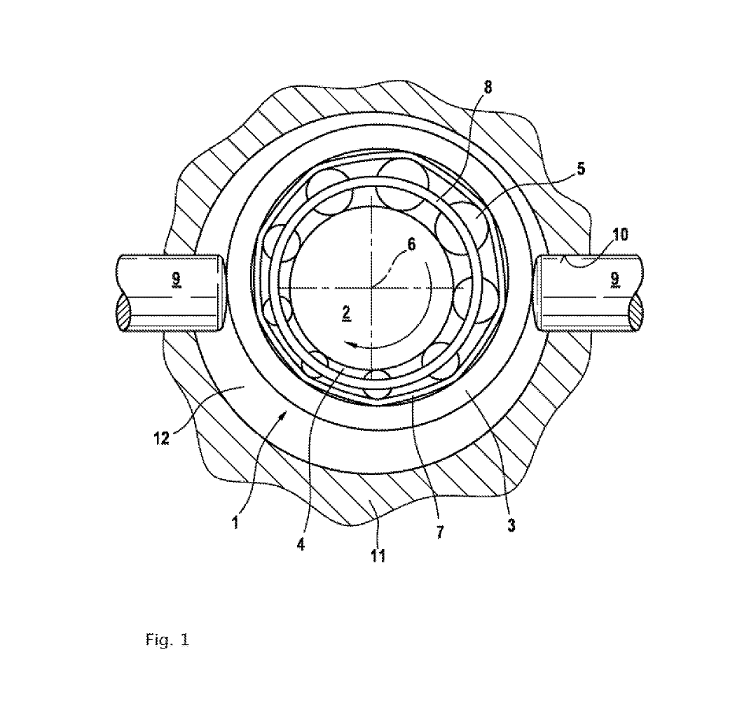

### PRIOR ART

The invention relates to an eccentric bearing having the features of the preamble of claim 1. The eccentric bearing according to the invention is intended, in particular, for an electro-hydraulic piston pump assembly of a hydraulic brake system of a motor vehicle. Such pump assemblies are used for generating a hydraulic brake pressure for brake actuation in traction-controlled and/or power-assisted brake systems.

Known eccentric bearings have an eccentric shaft which is attached in one piece or in another way rigidly and eccentrically to a motor shaft of an electric motor or to an output shaft in a gear which can be driven by means of the electric motor. A rolling bearing with a bearing ring concentrically surrounding the eccentric shaft is arranged on the latter and has rolling bodies which are arranged in a gap between the eccentric shaft and the bearing ring around the shaft, usually, but not necessarily, equidistantly. The rolling bodies are usually rollers or needles, but may also be other rolling bodies, for example balls. The bearing ring may be interpreted as an outer ring, and an inner ring may be present, for example pressed onto the eccentric shaft. However, an inner ring is not necessary, and the rolling bodies may also roll directly on the eccentric shaft. One or more pump pistons of the pump piston assembly bear with their end faces against the bearing ring on the outside. The pump pistons are pressed, for example by means of springs, into bearing contact against the bearing ring from outside.

During rotary drive, the eccentric shaft, on account of its eccentricity, executes movement on a circular path and at the same time rotates about itself. On account of the movement of the eccentric shaft on the circular path, the bearing ring also moves on one or on the same circular path and thereby drives the pump piston, bearing against it on the outside, in the desired lifting movement, in order to convey brake fluid or fluid in general by alternate suction intake and displacement, as is known from piston pumps. On account of its rolling mounting, the bearing ring does not co-rotate with the eccentric shaft.

In electro-hydraulic piston pump assemblies for hydraulic brake systems of motor vehicles, the eccentric bearings convert a rotational movement of an electric motor or of an output shaft of a gear into a lifting movement for the purpose of driving the pump pistons.

### DISCLOSURE OF THE INVENTION

The eccentric bearing according to the invention, having the features of claim 1, has a rotationally drivable shaft, on which is mounted a rolling bearing with a bearing ring surrounding the shaft and with rolling bodies arranged in a gap between the shaft and the bearing ring around the shaft, in which case the rolling bodies may be arranged equidistantly, but do not necessarily have to be. In contrast to known eccentric bearings, the shaft of the eccentric bearing according to the invention is provided concentrically to its axis of rotation, even though it is conceivable, and not ruled out by the invention, that the shaft is eccentric to its axis of rotation. Instead of or, if appropriate, in addition to eccentricity of the shaft, the bearing ring is eccentric to the shaft, and the rolling bodies have different diameters according to a different gap width between the shaft and the bearing ring because of the eccentricity of the bearing ring with respect to the shaft. The rolling bodies have diameters which are as large as the width of the gap between the bearing ring and the shaft at the circumferential point where the respective rolling body is located.

The rolling bodies of the eccentric bearing according to the invention are surrounded by a ring-shaped sling which acts upon the rolling bodies against a circumference of the shaft. The sling has the effect that the rolling bodies bear against the shaft and, when the shaft rotates, roll on it and consequently revolve around it. The sling of the eccentric bearing according to the invention ensures that the rolling bodies revolve around the rotating shaft even when there is play between the bearing ring and the rolling bodies. The circular movement of the bearing ring around the axis of the shaft is thereby ensured when the shaft is driven in rotation. The circular movement of the bearing ring gives rise, as described, to the lifting movement of the pump piston or pump pistons bearing against the bearing ring on the outside.

During rotary drive of the shaft, the rolling bodies roll on the shaft and in the bearing ring and revolve around the shaft, as is known from rolling bearings. In this case, the rolling bodies having a large diameter press the bearing ring away from the shaft, and on the opposite side where the rolling bodies having a small diameter are located the bearing ring approaches the shaft. As it were, the changing gap width, together with the rolling bodies, revolves around the rotationally driven shaft, that is to say the widest, the narrowest and any other gap width revolve with the rolling bodies around the shaft. The bearing ring moves on a circular path around the shaft with eccentricity with respect to the shaft. A rotational movement of the shaft is converted into a lifting movement of one or more pump pistons bearing against the bearing ring on the outside. On the assumption of a bearing ring not co-rotating with the shaft, the rolling bodies revolve at half the rotational speed of the shaft, and the speed at which the bearing ring moves on the circular path is likewise halved. The eccentric bearing according to the invention has a speed reduction, a revolution speed of the eccentricity of the bearing ring being halved in relation to the rotational speed of the shaft when the bearing ring is fixed in terms of rotation. The speed reduction has the advantage that a drive with a higher rotational speed is possible, which, with the performance being identical, enables a smaller and lighter electric motor to be used.

A further advantage of the eccentric bearing according to the invention is its simple and cost-effective set-up.

The eccentric bearing according to the invention is intended, in particular, for the explained use in an electro-hydraulic piston pump assembly for generating a brake pressure in a hydraulic brake system of a motor vehicle where it converts the rotational movement of an electric motor into a lifting movement for the purpose of driving pump pistons. However, the invention is not restricted to this use, but is directed, furthermore, at the eccentric bearing as such.

Advantageous refinements and developments of the invention specified in claim 1 are the subject matter of the sub-claims.

In a preferred refinement of the invention according to claim 2, the seam is elastic and acts upon the rolling bodies with prestress inwardly against the circumference of the shaft. The sling may be tensionally elastic for this purpose. The sling may also be tensionally rigid, that is to say inelastic in the tension direction and flexurally elastic. In this case, the sling is shorter than a circumcircle around the rolling bodies bearing against the circumference of the shaft and longer than a ring which surrounds the rolling bodies and which bears against the rolling bodies and runs between adjacent rolling bodies in a straight line and tangentially with respect to the adjacent rolling bodies. Between adjacent rolling bodies, such a sling is deformed elastically, its curvature decreasing. The elastic deformation of the sling in the direction of flexion causes the rolling bodies to be pressed elastically inward, that is to say with prestress against the circumference of the shaft. A suitable material for the sling is, for example, steel or another metal. The sling must be composed of a material which withstands the load which the rolling bodies exert upon it when they roll in the bearing ring, because the sling is located between the bearing ring of the rolling bodies, that is to say the rolling bodies roll on the sling.

It is conceivable to have one sling or a plurality of slings arranged next to one another in parallel with spacing, said sling or said slings being narrow in relation to a width of the bearing ring or a length of the rolling bodies in the axial direction. Such slings may be arranged in continuous grooves of the rolling bodies and/or in the inside of the bearing ring, so that the rolling bodies roll directly on the inside of the bearing ring, instead of on the sling which is arranged within the bearing ring. Claim 4 provides a strip-shaped sling which is approximately as wide as the bearing ring or is as wide as the rolling bodies are long in the axial direction. The sling is located between the rolling bodies and the bearing ring, and the rolling bodies roll on the sling.

### BRIEF DESCRIPTION OF THE DRAWING

The invention is explained in more detail below by means of an exemplary embodiment illustrated in the drawing. The single figure shows an eccentric bearing according to the invention in an end view.

### EMBODIMENT OF THE INVENTION

The eccentric bearing 1 according to the invention, illustrated in the drawing, has a shaft 2 which is surrounded by a bearing ring 3. Rollers 5 are arranged as rolling bodies around the shaft 2 in a gap 4 between the bearing ring 3 and the shaft 2. The bearing ring 3 and the rollers 5 may, if appropriate, be interpreted, together with the shaft 2, as rolling bearings. The shaft 2 can be driven in rotation about its axis 6, which is at the same time its axis of rotation, by means of an electric motor which cannot be seen in the drawing because it is located behind the drawing plane. The shaft 2 has no eccentricity. It may, for example, be the end of a motor shaft of the electric motor.

The bearing ring 3 is eccentric to the shaft 2, and a width of the gap 4 between the bearing ring 3 and the shaft 2 changes in a circumferential direction. Starting from a maximum gap width, which is at top right in the drawing, the gap width decreases in both circumferential directions to a minimum gap width which is located opposite the maximum gap width, that is to say at bottom left in the drawing.

The rollers 5 which form the rolling bodies have different diameters according to the different gap width. The diameters of the rollers 5 are in each case as large as the gap 4 between the bearing ring 3 and the shaft 2 at the point where the respective roller 5 is located.

When the shaft 2 is driven in rotation, the rollers 5 roll on a circumference of the shaft 2 and at the same time revolve at half the rotational speed of the shaft 2. Together with the two rollers 5 having the largest diameters, the maximum gap width of the gap 4 between the bearing ring 3 and the shaft 2 revolves. The minimum gap width of the gap 4 between the bearing ring 3 and the shaft 2 with the two rollers 5 having the smallest diameters likewise revolves around the shaft 2 at half the rotational speed of the shaft 2. In other words, an eccentricity of the bearing ring 3 with respect to the shaft 2 revolves around the shaft 2 when the shaft 2 is driven in rotation, the speed of revolution of the eccentricity being half the rotational speed of the shaft 2 when the bearing ring 3 does not co-rotate. The bearing ring 3 moves on a circular path around the axis 6 of the shaft 2 which is at the same time the axis of rotation of the latter, a speed of the circular movement of the bearing ring 3 being half the rotational speed of the shaft 2, that is to say speed reduction takes place.

The rollers 5 are surrounded by a strip 7 which is as wide as the rollers 5 are long in the axial direction. The strip 7 may also be interpreted, in general, as a ring-shaped sling. The strip 7 is located between the rollers 5, which form the rolling bodies of the eccentric bearing 1, and the bearing ring 3 of the latter. When the shaft 2 is driven in rotation, the rollers 5 roll on the strip 7 which is located on the inside of the bearing ring 3.

The strip 7 is composed, for example, of steel. The strip 7 may be interpreted as being tensionally rigid, that is to say as being inelastic in the tension direction and as being flexurally elastic. It is shorter than an imaginary circumcircle surrounding the rollers 5 and it is longer than an imaginary line which surrounds the rollers 5 and at the same time runs between adjacent rollers 5 in a straight line and tangentially with respect to the adjacent rollers 5. The strip 7 surrounding the rollers 5 is flexed elastically, and in the portions in which it bears against the rollers 5 its curvature is increased to the radii of the rollers 5, and in the portions between the rollers 5 a curvature of the strip 7 is reduced. On account of its elastic deformation, the strip 7 acts upon the rollers 5 radially inward against the circumference of the shaft 2. The strip 7 has the effect that the rolling bodies 5 roll on the shaft 2 and revolve around the shaft 2 when the shaft 2 is driven in rotation. Owing to the strip 7 surrounding the rollers 5, the rollers 5 which form the rolling bodies of the eccentric bearing 1 roll on the rotationally driven shaft 2 even when there is play between the bearing ring 3 and the rollers 5. The rollers 5, because they are acted upon elastically by the strip 7 radially inwardly, are free of play on the shaft 2.

The rollers 5 are accommodated rotatably in rectangular clearances, what are known as pockets, of a roller cage 8. Such roller cages 8 are known from rolling bearings. The roller cage 8, which may also be interpreted in general as a rolling body cage, holds the rollers 5 which form the rolling bodies of the eccentric bearing in their mutual spacing in the circumferential direction.

The strip 7 is not held fixedly in terms of rotation in the bearing ring 3, but is basically rotatable with respect to the bearing ring 3.

Pump pistons 9 bear with their end faces against the bearing ring 3 on the outside of the bearing ring 3. The pump pistons 9, of which only end faces are illustrated in the drawings, are arranged radially with respect to the shaft 2 and are pressed by piston springs, not illustrated, against the bearing ring 3 from outside. The pump pistons 9 are accommodated axially displaceably, that is to say displaceably radially to the shaft 2, in pump bores 10 of a pump casing 11. The eccentric bearing 1 is located in a cylindrical eccentric space 12 of the pump casing 11 between the two pump pistons 9 which, in the exemplary embodiment, are arranged opposite one another, that is to say in an opposed arrangement. By the shaft 2 being driven in rotation, the bearing ring 3 moves, without co-rotating with the shaft 2, at a speed half the rotational speed of the shaft 2 on a circular path around the axis 6 and axis of rotation of the shaft 2. The circular movement of the bearing ring 3 drives the pump pistons 9 in a lifting movement. The eccentric bearing 1 thus converts a rotational movement of the shaft 2 into a lifting movement for driving the pump pistons 9. The pump casing 11 is an integral part of what is known as a hydraulic block in which, in addition to the pump pistons 9, further hydraulic structural elements, not illustrated, such as solenoid valves of a traction control device for a hydraulic brake system of a motor vehicle, are arranged and are connected hydraulically to one another. Such hydraulic blocks are known per se and will not be explained in any more detail here.

1. An eccentric bearing for converting a rotational movement into a lifting movement comprising:
a rotationally drivable shaft;
a bearing ring eccentrically surrounding the shaft;
a plurality of rolling bodies arranged in a gap between the shaft and the bearing ring, the rolling bodies having different diameters according to a variable width of the gap; and
a ring-shaped sling configured to surround the rolling bodies and to act upon the rolling bodies against a circumference of the shaft.

2. The eccentric bearing as claimed in claim 1, wherein the sling is elastic.

3. The eccentric bearing as claimed in claim 1, wherein the sling is thin.

4. The eccentric bearing as claimed in claim 1, wherein the sling is a strip.

5. The eccentric bearing as claimed in claim 1, wherein the bearing ring is configured to rotate relative to the sling.

6. The eccentric bearing as claimed in claim 1, further comprising a rolling body cage.
